(19) United States
(12) Patent Application Publication
(10) Pub. No.: US 2008/0104403 A1
(43) Pub. Date: May 1, 2008

(54) METHODS AND APPARATUS FOR DATA AUTHENTICATION WITH MULTIPLE KEYS

(76) Inventor: Shay Gueron, Haifa (IL)

Correspondence Address: HANLEY, FLIGHT & ZIMMERMAN, LLC, 150 S. WACKER DRIVE, SUITE 2100, CHICAGO, IL, 60606, US

(21) Appl. No.: 11/537,086

(22) Filed: Sep. 29, 2006

(51) Int. Cl. H04L 9/00; G06F 12/14; H04L 9/32; G06F 11/30

(52) U.S. Cl. 713/176; 713/181; 713/187; 713/179

(57) ABSTRACT

Methods and apparatus for data authentication with multiple keys are disclosed. An example apparatus to authenticate data disclosed herein comprises a key verifier to verify a first key by comparing a test composite key value and a reference composite key value, wherein the test composite key value is generated from a first key value corresponding to the first key and a second key value corresponding to a second key, and a data verifier to verify the data using the first key when the key verifier determines that verification of the first key was successful, wherein verification is successful when the test composite key value substantially matches the reference composite key value.

### FIELD OF THE DISCLOSURE

This disclosure relates generally to data authentication and, more particularly, to methods and apparatus for data authentication with multiple keys.

### BACKGROUND

Many of today's data processing devices, systems and applications are designed to process data only if the data can be authenticated as originating from a legitimate data provider. For example, many multimedia devices, systems and applications employ digital rights management (DRM) to protect the rights of data providers and prevent piracy by allowing presentation of multimedia content only if the content's authenticity is verified. As another example, many devices and systems employ integrity protection by using data authentication to allow execution of only proprietary code and/or trusted boot sequences originating from an authenticated, legitimate provider. Data authentication techniques typically employ public key authentication algorithms in which a private key is associated with a legitimate provider and used to generate a signature to sign the authentic data. Data authenticity can then be verified using a public key corresponding to the private key to determine whether the signature accompanying the data is valid and, thus, whether the data itself is authentic.

### BRIEF DESCRIPTION OF THE DRAWINGS

FIG. 1 is a block diagram of a first example data authentication system that supports multiple keys.

FIG. 2 is a block diagram of a second example data authentication system that supports multiple keys.

FIG. 3 is a block diagram of an example data authenticator that may be used to implement the example authentication systems of FIGS. 1 and/or 2.

FIG. 4 is a flowchart representative of example machine readable instructions that may be executed to implement the example data authenticator of FIG. 3.

FIG. 5 is a flowchart representative of example machine readable instructions that may be executed to perform key verification to implement the data authenticator of FIG. 3 and/or the example machine readable instructions of FIG. 4.

FIG. 6 is a flowchart representative of example machine readable instructions that may be executed to perform data verification to implement the data authenticator of FIG. 3 and/or the example machine readable instructions of FIG. 4.

FIG. 7 is a block diagram of an example computer that may execute the example machine readable instructions of FIGS. 5, 6 and/or 7 to implement the example data authenticator of FIG. 3.

### DETAILED DESCRIPTION

Example methods and apparatus for data authentication with multiple keys are illustrated herein. The example data authentication methods and apparatus illustrated herein can be used to authenticate a variety of types of data, such as, but not limited to, program code, data files, digital identities, etc. As such, the example data authentication methods and apparatus illustrated herein can be used to implement a variety of devices, systems, applications, etc., that utilize authenticated data. For example, devices, systems and/or applications may be implemented using the example methods and/or apparatus illustrated herein to execute program code and/or process input data only if the program code and/or input data is signed by a legitimate (e.g., trusted) provider. Examples of such devices, systems and applications include, but are not limited to, digital rights management (DRM) applications (e.g., such as for use with Microsoft's Media Player, Real Network's Real Player, Apple's Quick Time media player, etc.), electronic systems that support execution of only proprietary program code (e.g., such as cable/satellite set-top boxes, video game consoles, etc.), computers that support execution of only trusted boot sequences, etc.

To perform data authentication, the example methods and apparatus illustrated herein authenticate data by verifying a signature used to digitally “sign” the data. The signature used in the illustrated examples is generated from the data and a key based on any authentication technique. The signature used in the illustrated examples is also verified based on a key and according to the authentication technique used to generate the signature. The key used to verify the signature may be the same key used to generate the signature or a different key than the one used to generate the signature. For example, the signature may be generated by processing the data with a public key authentication algorithm based on a private key associated with the provider of the data. In such an example, the methods and apparatus illustrated herein authenticate the data by verifying the signature according to the public key authentication algorithm and based on a public key associated with the data provider and paired with the private key. For authentication to be meaningful, the public key in the preceding example should be “trusted” or, in other words, known to be the valid, or “authentic,” public key associated with the signature used to sign the data and, thus, capable of authenticating the data. In contrast, if the validity, or authenticity, of public key was unknown, then verification of the signature using the public key would simply indicate that the signature was generated properly. However, the source of the data and the signature would still be unknown because the source of the public key was unknown, thus rendering the authentication process meaningless in such a scenario.

To verify the signature used to sign the data and, thus, authenticate the data, the example methods and apparatus illustrated herein first verify the trustworthiness of the key to be used to verify the signature. The example methods and apparatus illustrated herein then verify the data only if the key is determined to be trustworthy. Furthermore, the example methods and apparatus illustrated herein support authentication using a plurality of keys, any one of which can be used to authenticate the data based on the particular signature used to sign the data. Accordingly, the example methods and apparatus illustrated herein can verify any one of the plurality of keys and then use the verified key to verify the particular signature used to sign the data to be authenticated. Moreover, the example methods and apparatus illustrated herein are configured to verify any key in the plurality of keys based on a single reference composite value and a plurality of key values corresponding to the plurality of keys. The single reference composite value and/or the plurality of key values do not need to be updated when a different signature is used to sign the data and, thus, a different key is to be verified before being used to authenticate the data. Such an implementation is advantageous because the single reference composite value and/or the plurality of key values may be stored locally in, for example, the device, system, application, etc., implemented using the example methods and apparatus illustrated herein rather than needing to be retrieved each time a different signature is used to sign the data to be authenticated. Furthermore, the single reference composite value and/or the plurality of key values may have smaller, and potentially considerably smaller, sizes than the keys used to verify the signatures.

For example, some example methods and apparatus illustrated herein support public key authentication algorithms for authenticating data. As such, these example methods and apparatus can verify any one of a plurality of public keys corresponding to a particular signature used to sign the data to be authenticated. Additionally or alternatively, some of the example methods and apparatus illustrated herein employ one or more hash functions to determine the reference composite value and/or the plurality of key values used to verify any one of the plurality of public keys. For example, the plurality of key values may be determined by processing each public key in the plurality of keys with the hash function. The composite reference value may then be determined by concatenating the plurality of key values (e.g., in a predetermined order) and then processing the concatenation result with the same or a different hash function. To verify a particular input public key to be used for data authentication, a public key value corresponding to the input public key is determined by processing the input public key with the hash function used to generate the plurality of key values. The determined public key value is then concatenated with the key values corresponding to the other public keys in the plurality of keys. The concatenation result is then processed with the hash function used to generate the reference composite value and the result is compared with the reference composite value. If the result of the comparison indicates that the hashed concatenation result and the reference composite value substantially match, verification of the input public key is successful. The input public key may then be used to verify the signature to authenticate the corresponding data.

Some example methods and apparatus illustrated herein also condition data authentication on certain available external information. For example, some of these example methods and/or apparatus may invalidate the data even if the public key and the signature are verified if, for example, it is known that the public key has expired, has been revoked, etc. Additionally or alternatively, some of the example methods and/or apparatus may vary the authentication algorithm used for data authentication based on which of the plurality of keys is provided to the method and/or apparatus as indicated, for example, by a key identifier. For example, if the key identifier indicates that a first key is provided for data authentication, the example methods and/or apparatus may employ a first authentication algorithm (e.g., such as a 1024-bit RSA algorithm), whereas if the key identifier indicates that a second key is provided for data authentication, the example methods and/or apparatus may employ a second authentication algorithm (e.g., such as a 2048-bit RSA algorithm) to verify the signature. Furthermore, only one reference composite value is needed regardless of the bit length of the public key associated with the particular authentication algorithm selected for data authentication. This is because the reference composite value is generated as the output of a hash function and, as such, has a known, fixed length independent of the bit length of the input to the hash function.

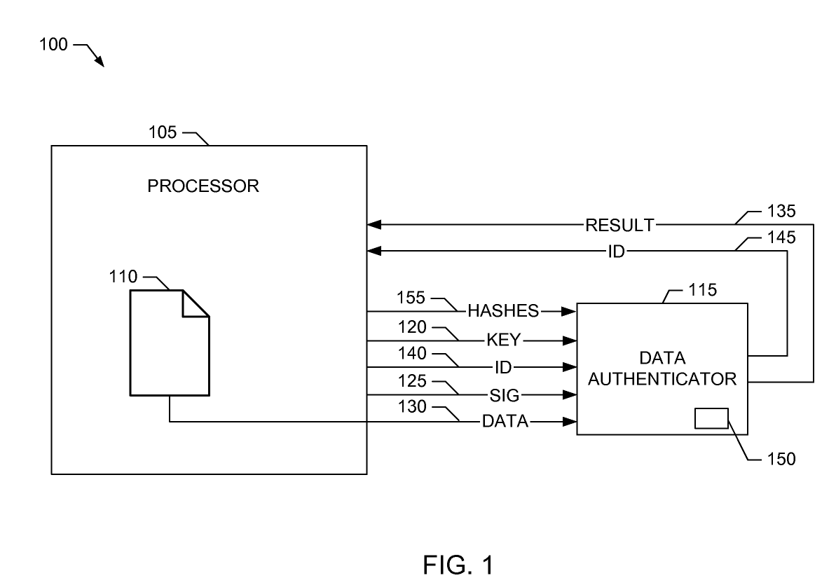

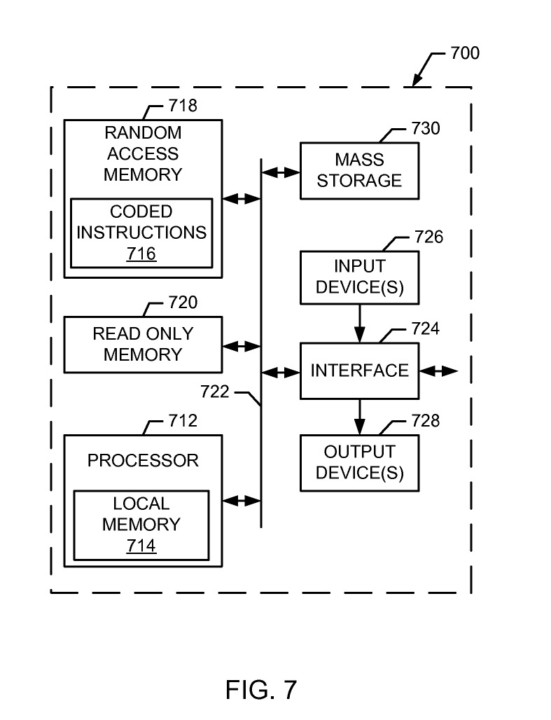

A block diagram of a first example data authentication system 100 that supports multiple keys is shown is illustrated in FIG. 1. The example data authentication system 100 includes a processor 105 to process data 110 only if the data 110 is authentic. The processor 105 may be implemented by any type of processor, such as, for example, the processor 712 of FIG. 7. The processor 105 may perform any type of processing on the data 110. For example, if the data 110 includes program code, the processor 105 in the illustrated example is configured to execute the program code 110 only if the program code 110 is signed by a legitimate data provider. Such a processor configuration may be used to implement, for example, devices and/or systems designed to execute only proprietary code (e.g., such as cable/satellite set-top boxes, video game consoles, etc.), devices and/or systems designed to execute only trusted boot sequences, etc. Additionally or alternatively, if the data 110 includes data files, digital signatures and/or other digital information, the processor 105 in the illustrated example is configured to process the data 110 only if the data 110 is signed by a legitimate data provider. Such a processor configuration may be used to implement, for example, devices, systems and/or applications employing digital rights management (DRM) (e.g., such as Microsoft's Media Player, Real Network's Real Player, Apple's Quick Time application, etc).

To authenticate the data 110, the example data authentication system 100 includes a data authenticator 115. The data authenticator 115 of the illustrated example is implemented as a device separate from the processor 105 and employs any key-based data authentication technique to authenticate the data 110. For example, the data authenticator 115 of the illustrated example employs a public key authentication algorithm that utilizes a private key to sign the data 110 and a corresponding public key to authenticate the signed data 110. The private key is associated with and known only to the legitimate provider of the data 110. To sign the data 110, the legitimate data provider processes the data 110 with the public key authentication algorithm based on the provider's private key. The result is a signature used to sign the data 110 and associated with the legitimate provider. The data authenticator 115 authenticates the data 110 by processing the data 110 and its associated signature with the public key encryption algorithm based on the public key corresponding to the legitimate provider's private key. As such, the data authenticator 115 in the illustrated example includes a key input 120, a signature input 125 and a data input 130 to accept the public key, signature and data 110 for input to the public key authentication algorithm.

The data authenticator 115 in the illustrated example indicates the result of authenticating the data 110 via a result output 135. For example, if the signature applied to the signature input 125 is determined to be valid, the data authenticator 115 indicates via the result output 135 that verification of the authenticity of the data 110 is successful. Alternatively, if the signature applied to the signature input 125 is determined to be invalid, the data authenticator 115 indicates via the result output 135 that verification of the authenticity of the data 110 is unsuccessful.

Furthermore, the data authenticator 115 in the illustrated example supports signing and authentication of the data 110 with a plurality of private/public key pairs. Additionally, the data authenticator 115 may implement different public key authentication algorithms depending on which private/public key pair is used to sign and authenticate the data 110. As such, the data authenticator 115 includes a key identifier (ID) input 140 to identify which one of the plurality of public keys is applied to the key input 120. The ID input 140 allows the data authenticator 115 to tailor authentication to the specific key applied to the key input 120. Additionally, the data authenticator 115 includes an ID output 145 to indicate to which one of the plurality of public keys the authentication result indicated by the result output 135 applies. In this way, the data 110 may be authenticated based on a plurality of public keys and, if authentication is unsuccessful with one public key, another public key may be used to authenticate the data 110.

The data authenticator 115 supports data authentication with a plurality of public keys by first verifying the trustworthiness (e.g., the authenticity) of the public key applied to the key input 120 and then, if trustworthiness is verified, using the input public key to authenticate the data 110. The data authenticator 115 of the illustrated example verifies the public key applied to the key input 120 based on a single stored composite hashed key value 150 and a plurality of hashed key values corresponding to the plurality of possible keys capable of being used for data authentication. The plurality of hashed key values is provided to the example data authenticator 115 via the hashes input 155. In the illustrated example, the composite hashed key value 150 and the plurality of hashed key values applied to the hashes input 155 do not need to be updated when different private/public key pairs from the plurality of possible private/public key pairs are used to sign and authenticate the data 110. Such an implementation is advantageous because the composite hashed key value 150 and the plurality of hashed key values applied to the hashes input 155 may be stored locally in, for example, the processor 105 and/or the data authenticator 115 rather than needing to be retrieved each time a different private/public key pair is used to sign and authenticate the data 110. Furthermore, the composite hashed key value 150 and the plurality of hashed key values applied to the hashes input 155 may have smaller, and potentially considerably smaller, sizes than the plurality of possible private/public key pairs used to sign and authenticate the data 110.

The composite hashed key value 150 in the illustrated example is constructed by concatenating the plurality of hashed key values (e.g., in a predetermined order) and then processing the concatenation result with the same or a different hash function than the one used to determine the plurality of hashed key values. To verify a particular public key applied to the key input 120, a hashed public key value is determined for the input public key by processing the input public key with the hash function used to generate the plurality of hashed key values. The determined hashed public key value is then concatenated with a plurality of hashed key values applied to the hashes input 155 and corresponding to the public keys in the plurality of possible public keys other than the particular public key applied to the key input 120. The concatenation result is then processed with the hash function used to generate the reference hashed composite key value 150 and the result is compared with the reference hashed composite key value 150. If the result of the comparison indicates that hashed concatenation result and the stored composite hashed key value 150 substantially match, verification of the public key applied to the key input 120 is successful. The input public key may then be used to verify the signature applied to the signature input 125 to authenticate the corresponding data 110 applied to the data input 130.

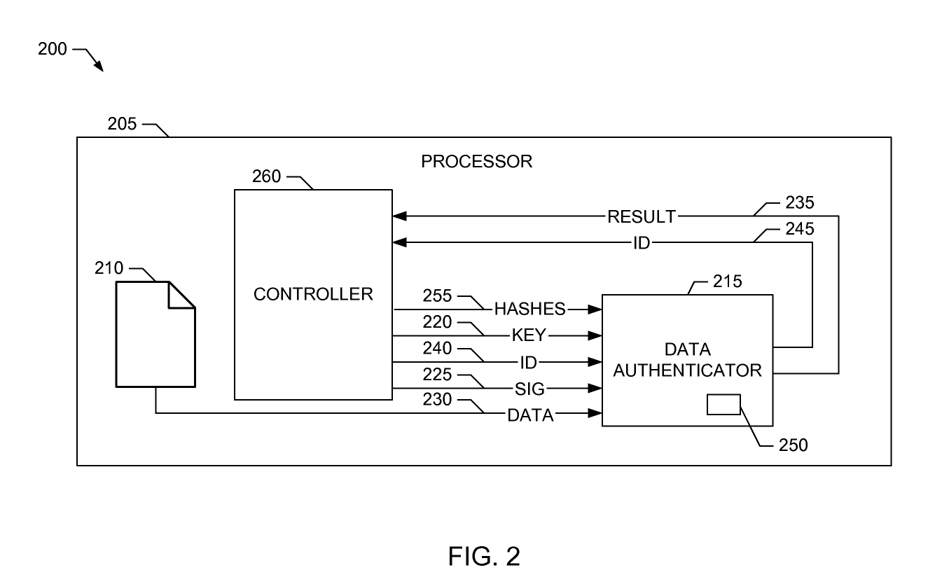

A block diagram of a second example data authentication system 200 that supports multiple keys is illustrated in FIG. 2. The example data authentication system 200 possesses functionality similar to that of the first example data authentication system 100. Similar to the example data authentication system 100, the example data authentication system 200 includes a processor 205 to process data 210 only if the data 210 is authentic. The processor 205 may be implemented by any type of processor, such as, for example, the processor 712 of FIG. 7. The processor 205 may perform any type of processing on the data 210. For example, if the data 210 includes program code, the processor 205 in the illustrated example is configured to execute the program code 210 only if the program code 210 is signed by a legitimate data provider. Additionally or alternatively, if the data 210 includes data files, digital signatures and/or other digital information, the processor 205 in the illustrated example is configured to process the data 210 only if the data 210 is signed by a legitimate data provider.

To authenticate the data 210, the example data authentication system 200 includes a data authenticator 215. The data authenticator 215 possesses functionality similar to that of the data authenticator 115 of FIG. 1. However, instead of being implemented as a device separate from the processor 205, the data authenticator 215 in the illustrated example is implemented as an application executed by the processor 205. Like the example data authenticator 115, the data authenticator 215 in the illustrated example employs any public key authentication algorithm to authenticate the data 210. Furthermore, like the example data authenticator 115 of FIG. 1, the data authenticator 215 in the illustrated example supports signing and authentication of the data 210 with a plurality of private/public key pairs.

As such, the example data authenticator 215 includes a key input 220, a signature input 225 and a data input 230 to accept the public key, signature and data 110 for input to the public key authentication algorithm. The example data authenticator 215 further includes a result output 235, an ID input 240 and an ID output 245 to select a particular public key from the plurality of public keys to authenticate the data 210 and indicate the result of authenticating the data 210 with the selected public key. Like the example data authenticator 115, the data authenticator 215 of the illustrated example uses a composite hashed key value 250 and a plurality of hashed key values applied to a hashes input 255 to verify the trustworthiness of the public key applied to the key input 220 before using the input public key to authenticate the data 210.

The example data authentication system 200 also includes a controller 260 to provide the inputs for and evaluate the result of authenticating the data 210 via the data authenticator 215. The controller 260 of the illustrated example is implemented by the processor 205 and provides the public key, key ID, plurality of hashed key values and signature to the key input 220, the ID input 240, the hashes input 255 and the signature input 225, respectively, to enable the data authenticator 215 to authenticate the data 210. The controller 260 of the illustrated example further processes the result output 235 and the ID output 245 of the data authenticator 215 to determine whether the data 210 is valid. The example controller 260 may also utilize additional (e.g., external) information to determine the validity of the data 210. For example, the controller 260 may invalidate the data 210 even if the data 210 is authenticated by the data authenticator 215 if additional available information indicates that the public key applied to the key input 220 has expired, has been revoked, etc.

The controller 260 of the illustrated example also supports varying the authentication algorithm used by the data authenticator 215 to authenticate the data 210. In particular, the data authenticator 215 of the illustrated example is configured to support multiple public key authentication algorithms. A particular one of the multiple public key authentication algorithms is selected based on the ID input 240. Thus, the controller 260 selects which one of the multiple public key authentication algorithms is to be used to authenticate the data 210 by inputting the appropriate key ID value to the ID input 240 and providing the corresponding public key to the key input 220. For example, if the ID input 240 indicates that a first key is applied to the key input 220, the example data authenticator 215 employs a first authentication algorithm (e.g., such as a 1024-bit RSA algorithm) to authenticate the data 210, whereas if the ID input 240 indicates that a second key is applied to the key input 220, the example data authenticator 215 employs a second authentication algorithm (e.g., such as a 2048-bit RSA algorithm) to authenticate the data 210.

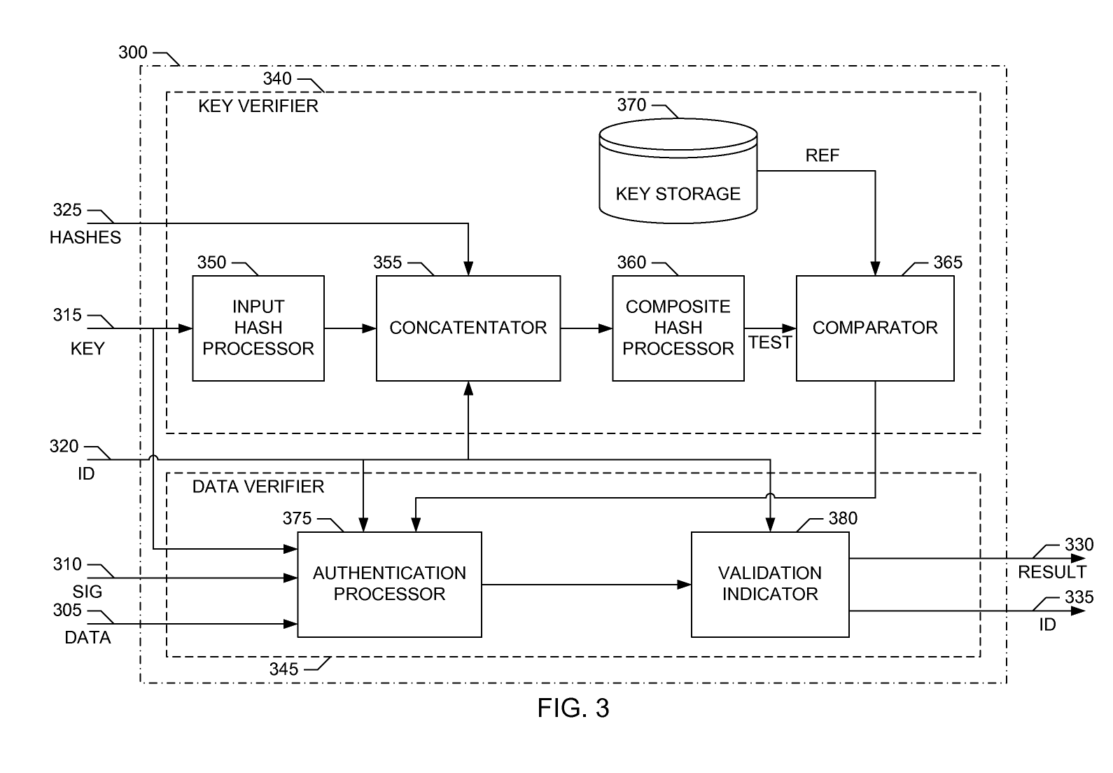

A block diagram of a data authenticator 300 that may be used to implement the example data authentication systems 100 and/or 200 of FIGS. 1 and 2, respectively, is illustrated in FIG. 3. The data authenticator 300 employs any public key authentication algorithm to authenticate data applied to a data input 305. Public key authentication algorithms utilize a private key to enable a legitimate data provider to sign the data and a corresponding public key to enable a recipient to verify the authenticity of the data. To sign the data, the legitimate data provider processes the data with the public key authentication algorithm using the provider's private key. The result is a signature that accompanies the data and which is associated with the legitimate provider. A recipient authenticates the data by processing the data and its companion signature with the public key encryption algorithm using a public key corresponding to the legitimate provider's private key. Thus, to support authentication of the data applied to the input 305, the data authenticator 300 in the illustrated example includes a signature input 310 to accept a signature accompanying the input data and a key input 315 to accept a public key for verifying the authenticity of the input data.

Additionally, the data authenticator 300 of the illustrated example supports signing and authentication of the input data with a plurality of private/public key pairs. Furthermore, the example data authenticator 300 may implement different public key authentication algorithms depending on which private/public key pair is used to sign and authenticate the input data. As such, the example data authenticator 300 includes an ID input 320 to identify which one of the plurality of possible public keys is applied to the key input 315. The ID input 320 allows the example data authenticator 300 to tailor authentication to the specific key applied to the key input 315.

The example data authenticator 300 supports data authentication with a plurality of public keys by first verifying the trustworthiness (e.g., the authenticity) of the public key applied to the key input 315 and then, if trustworthiness is verified, using the verified input public key to authenticate the input data. As discussed in greater detail below, the example data authenticator 300 verifies the public key applied to the key input 315 based on a plurality of hashed key values applied to a hashes input 325. The plurality of hashed key values corresponds to the plurality of public keys that may be used to authenticate the input data. The plurality of hashed key values is determined by processing each of the plurality of possible public keys with any hash function. All of the plurality of public key values except for the public key value corresponding to the public key applied to the key input 315 are applied to the hashes input 325. This plurality of public key values, which may be pre-computed or determined on-the-fly, are used to verify the authenticity of the input public key, as discussed in greater detail below.

The data authenticator 300 of the illustrated example includes two outputs, namely, a result output 330 and an ID output 335. In the illustrated example, the result output 330 indicates whether authentication of the data applied to the data input 305 was successful or unsuccessful. The ID output 335 in the illustrated example further identifies the public key in the plurality of possible public keys for which the data authentication was successful or unsuccessful as indicated by the result output 330.

To perform data authentication, the data authenticator 300 of the illustrated example includes a key verifier 340 to verify the authenticity of the public key applied to the key input 315 and a data verifier 345 to verify the authenticity of the data applied to the data input 305 when the key verifier 340 determines that the input public key is authentic. The key verifier 340 of the illustrated example includes an input hash processor 350 to determine the hashed key value corresponding to the public key applied to the key input 315. For example, if Nₖ denotes the public key applied to the key input 315, then the output of the input hash processor 350 is given by Xₖ=HASH(Nₖ), where HASH( ) denotes any hash function.

The output of the input hash processor 350, as well as the plurality of hashed key values applied to the hashes input 325, are applied to a concatenator 355 included in the key verifier 340 of the illustrated example. The example concatenator 355 further accepts a public key identifier applied to the ID input 320 that indicates (i) which one of the plurality of possible public keys is applied to the key input 315 and (ii) which one of the plurality of hashed key values is not included in the plurality of hashed key values applied to the hashes input 325. Continuing with the preceding example, assume that the public key identifier has a value of k indicating that the k^{th} public key (denoted as Nₖ) in the plurality of possible public keys is applied to the key input 315. If the plurality of possible public keys is denoted as Nⱼ, j=1, . . . , n, then the plurality of hashed key values applied to the hashes input 325 is given by hNⱼ=HASH((Nj)), j=1, . . . , n and j≠k. The example concatenator 355 concatenates the plurality of hashed values applied to the hashes input 325 and the hashed key value determined by the input hash processor 350 in a predetermined order using the public key identifier applied to the ID input 320. In particular, the example concatenator 355 uses the public key identifier (e.g., having a value of k in the preceding example) to determine at which position to place the hashed key value determined by the input hash processor 350 and corresponding to the public key applied to the key input 315. Thus, continuing with the preceding example, the output of the example concatenator 355 would be hN₁∥hN₂∥ . . . ∥Xₖ∥ . . . ∥hNₙ, where Xₖ is the hashed key value corresponding to the input public key as discussed above, and “∥” denotes concatenation.

The key verifier 340 of the illustrated example further includes a composite hash processor 360 to determine a test composite hashed key value by processing the output of the concatenator 355 with any hash function. The hash function implemented by the composite hash processor 360 may be the same as or different from the hash function implemented by the input hash processor 350. For example, if the composite hash processor 360 implements the same hash function as the input hash processor 350 then, continuing with the preceding example, the output of the composite hash processor 360 is the test composite hashed key value given by T=HASH(hN₁∥hN₂∥ . . . ∥Xₖ∥ . . . ∥hNₙ).

To authenticate the public key applied to the key input 315, the key verifier 340 of the illustrated example includes a comparator 365 to compare the test composite hashed key value output by the composite hash generator 360 and a reference composite hashed key value stored in a key storage unit 370. The reference composite hashed key value is determined by concatenating all of the plurality of possible public key values and then processing the result with the same hash function implemented by the composite hash processor 360. The reference composite hashed key value is independent of the particular public key applied to the key input 315 because it is generated based on hashed key values corresponding to all of the plurality of possible public keys. Thus, the reference composite hashed key value is pre-computed in the illustrated example and stored in the key storage unit 370, which may be implemented using any type of memory element, device, etc.

Continuing with the preceding example, if the plurality of possible public keys are denoted as Nⱼ, j=1, . . . , n, and the corresponding plurality of hashed key values is given by hHⱼ=HASH ((Nj)), j=1, . . . , n, then the reference composite hashed key value is given by hKEYS=HASH(hN₁∥hN₂∥ . . . ∥hNₖ∥ . . . ∥hNₙ). The example comparator 365 then compares hKEYS, the reference composite hashed key value, with T, the test composite hashed key value given above. If the reference composite hashed key value (e.g., hKEYS) and the test composite hashed key value (e.g., T) substantially match, then the example comparator 365 indicates that authentication of the public key applied to the key input 315 (e.g., Nₖ) was successful. Otherwise, the example comparator 365 indicates that authentication of the input public key (e.g., Nₖ) was unsuccessful. If authentication is successful, the public key applied to the key input 315 is used to authenticate the data applied to the data input 305.

The example data verifier 345 of the illustrated example includes an authentication processor 375 to authenticate the data applied to the data input 305 when the example key verifier 340 verifies that the public key applied to the key input 315 is authentic. The example authentication processor 375 implements any public key authentication algorithm to authenticate the input data. As such, the example authenticator accepts as inputs the data applied to the data input 305, the companion signature applied to the signature input 310 and the public key applied to the key input 315. Additionally, the authentication processor 375 of the illustrated example accepts as an input the output of the example comparator 365 which indicates whether verification of the input public key was successful or unsuccessful. If the output of the example comparator 365 indicates that verifying the authenticity of the input public key was successful, the example authentication processor 375 performs any public key authentication algorithm to verify that the signature applied to the signature input 310 is a correct signature for the input data and, thus, that the input data is authentic.

The authentication processor 375 of the illustrated example also accepts as an input the key identifier applied to the ID input 320. By accepting the key identifier as an input, the example authentication processor 375 can tailor the public key authentication algorithm to the particular public key from the plurality of possible public keys that is applied to the key input 315. For example, the authentication processor 375 of the illustrated example may implement a first public key authentication algorithm (e.g., such as a 1024 bit RSA algorithm) if a first public key (e.g., N₁) is applied to the key input 315. However, if a second public key (e.g., N₂) is applied to the key input 315, the example authentication processor 375 may implement a second public key authentication algorithm (e.g., such as a 2048 bit RSA algorithm). Persons of ordinary skill in the art will appreciate public keys having different bit lengths may be applied to the key input 315 and, thus, public key authentication algorithms employing different length keys are supported, because the hash function(s) used to implement the input hash processor 350 and the composite hash processor 360 used to determine the plurality of hashed key values applied to the hashes input 325 take inputs having variable lengths and produce outputs having a fixed, predetermined length. As such, the plurality of hashed key values and the hashed key value output by the input hash processor 350 will all have the same length regardless of the individual lengths of each of the plurality of public keys capable of data authentication. Furthermore, the test composite hashed value and the reference composite hashed value used by the key verifier 340 to verify the input public key applied to the key input 315 will each have the same bit length regardless of the lengths of the constituent hashed key values used to create the respective composite hashed key values.

The data verifier 345 of the illustrated example also includes a validation indicator 380 to indicate the result of verifying the authenticity of the data applied to the data input 305. The example validation indicator 380 processes the result of the example authentication processor 375 to determine whether verification of the authenticity of data applied to the data input 305 was successful or unsuccessful for the public key identified by the key identifier applied to the ID input 320. The example validation indicator 380 indicates whether data authentication was successful or unsuccessful via the result output 330. Additionally, the example validation indicator 380 identifies the key to which the data authentication result applies via the ID output 335.

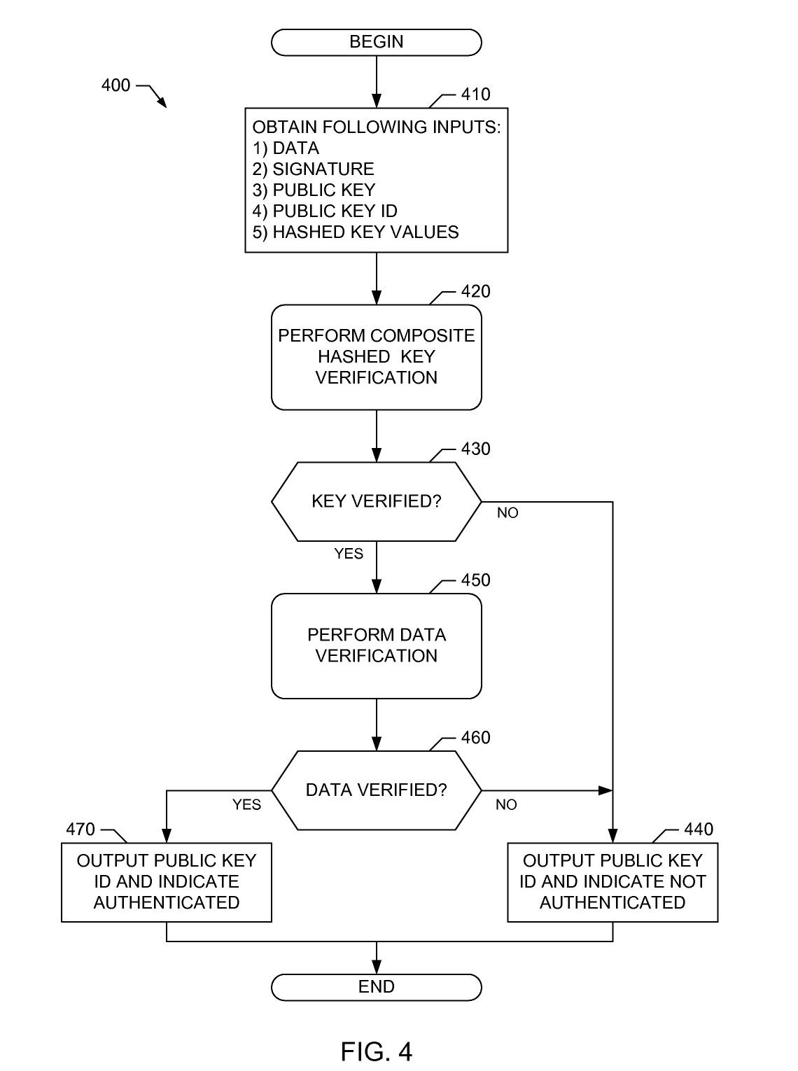

Flowcharts representative of example machine readable instructions that may be executed to implement the example data authentication system 100 of FIG. 1, the example data authentication system 200 of FIG. 2 and/or the example data authenticator 300, the example key verifier 340, the example data verifier 345, the example input hash processor 350, the example concatenator 355, the example composite hash processor 360, the example comparator 365, the example authentication processor 375 and/or the example validation indicator 380 of FIG. 3 are shown in FIGS. 4-6. In these examples, the machine readable instructions represented by each flowchart may comprise one or more programs for execution by: (a) a processor, such as the processor 712 shown in the example computer 700 discussed below in connection with FIG. 7, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 712, but persons of ordinary skill in the art will readily appreciate that the one or more programs and/or portions thereof could alternatively be executed by a device other than the processor 712 and/or embodied in firmware or dedicated hardware in a well-known manner (e.g., implemented by an application specific integrated circuit (ASIC), a programmable logic device (PLD), a field programmable logic device (FPLD), discrete logic, etc.). For example, any or all of the example data authentication system 100, the example data authentication system 200, the example data authenticator 300, the example key verifier 340, the example data verifier 345, the example input hash processor 350, the example concatenator 355, the example composite hash processor 360, the example comparator 365, the example authentication processor 375 and/or the example validation indicator 380 could be implemented by any combination of software, hardware, and/or firmware. Also, some or all of the machine readable instructions represented by the flowchart of FIGS. 4-6 may be implemented manually. Further, although the example machine readable instructions are described with reference to the flowcharts illustrated in FIGS. 4-6, persons of ordinary skill in the art will readily appreciate that many other techniques for implementing the example methods and apparatus described herein may alternatively be used. For example, with reference to the flowcharts illustrated in FIGS. 4-6, the order of execution of the blocks may be changed, and/or some of the blocks described may be changed, eliminated, combined and/or subdivided into multiple blocks.

Example machine readable instructions 400 that may be executed to implement the example data authenticator 115 of FIG. 1, the example data authenticator 215 of FIG. 2 and/or the example data authenticator 300 of FIG. 3 are shown in FIG. 4. The example machine readable instructions 400 support data authentication with multiple keys by (i) verifying the authenticity of an input key from a plurality of possible keys that may be used to authenticate the data and (ii) verifying the authenticity of the data using the input key when the authenticity of the input key is verified. The example machine readable instructions 400 further implement any public key authentication algorithm and may be executed whenever input data is to be authenticated. Execution of the example machine readable instructions begins at block 410 at which a data authenticator, such as, for example, the example data authenticator 300 of FIG. 3, obtains (i) the input data to be authenticated, (ii) an input signature that signs the input data, (iii) an input public key from a plurality of possible public keys capable of authenticating the input data, (iv) a key identifier (ID) to indicate which of the plurality of possible public keys has been obtained and (v) a plurality of hashed key values used to verify the authenticity of the input public key.

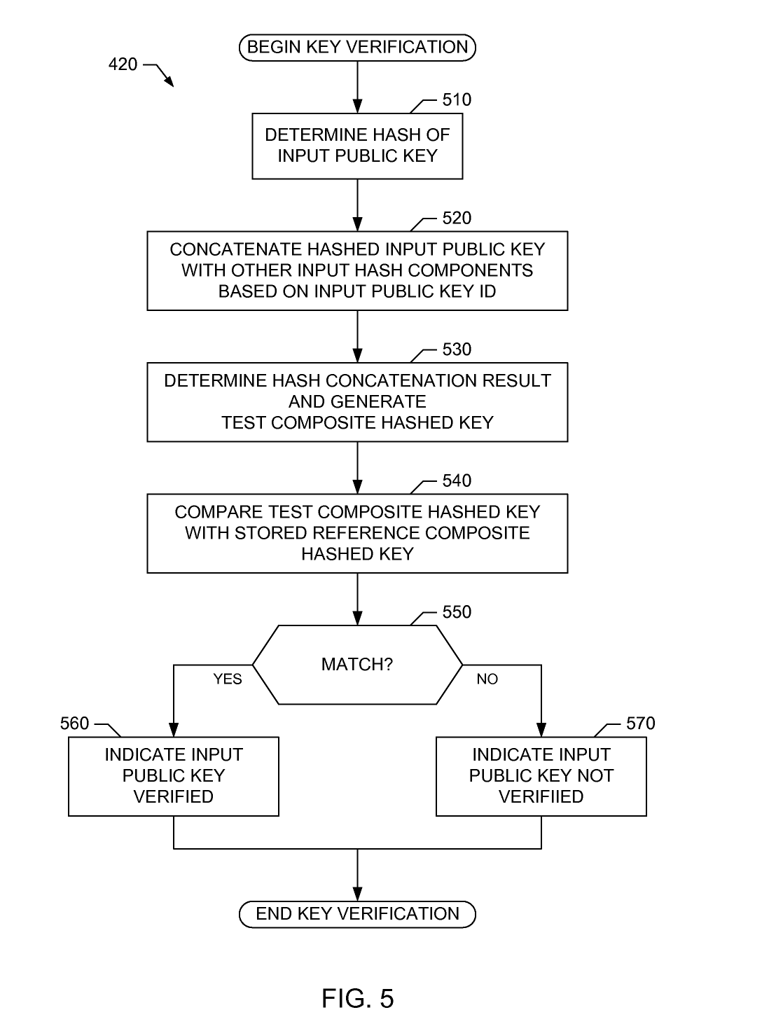

Next, control proceeds to block 420 at which the example data authenticator 300 performs key verification on the input public key obtained at block 410 to determine whether the input public key is authentic. For example, and as discussed above, at block 420 the example key verifier 340 included in the example data authenticator 300 may determine a test composite hashed key value based on a hashed key value corresponding to the input public key and the plurality of hashed key values obtained at block 410. The example key verifier 340 may compare this test composite hashed key value to a reference composite hashed key value to determine whether the input public key obtained at block 310 is authentic and suitable for determining the authenticity of the input data. Example machine readable instructions which may be executed to implement the processing at block 420 are shown in FIG. 5 and discussed in greater detail below.

After processing at block 420 completes, control proceeds to block 430 at which the example data authenticator 300 determines whether verification of the authenticity of the input public key obtained at block 410 was successful. If verification of the input public key's authenticity was unsuccessful (block 430), control proceeds to block 440. At block 440, the example data authenticator 300 outputs an indication that the input data obtained at block 410 was not able to be authenticated. Additionally, the example data authenticator outputs the key ID corresponding to the input public key obtained at block 410 to indicate for which of the plurality of possible public keys authentication of the input data was unsuccessful. Execution of the example machine readable instructions 400 then ends.

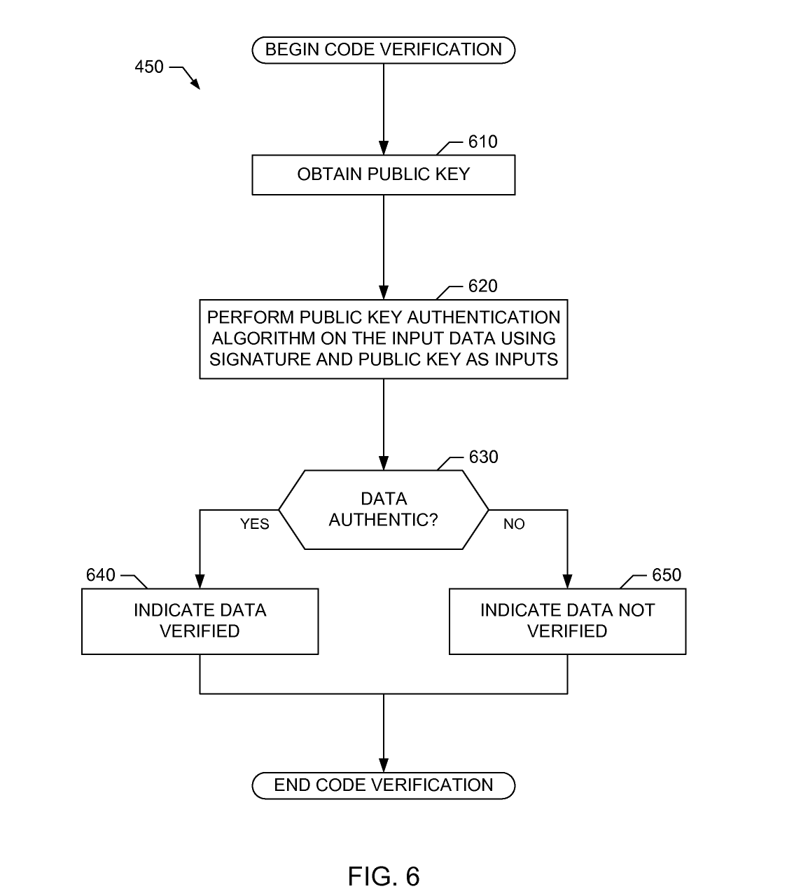

However, if verification of the input public key's authenticity was successful (block 430), control proceeds instead to block 450. At block 450, the example data authenticator 300 verifies the authenticity of the input data obtained at block 410 using the verified input public key. For example, and as discussed above, at block 450 the example data verifier 345 included in the example data authenticator 300 may implement any public key authentication algorithm to authenticate the input data obtained at block 410 using the input signature and input public key also obtained at block 410. Additionally, the particular public key authentication algorithm implemented by the example data verifier 345 at block 450 may be tailored according to which of the plurality of possible public keys was obtained at block 410 as indicated by the input key ID also obtained at block 410. For example, at block 410 the example data verifier 345 may implement a first public key authentication algorithm if the input key ID indicates that a first public key was obtained at block 410, whereas the example data verifier 345 may implement as second public key authentication algorithm if the input key ID indicates that a second public key was obtained at block 410. Example machine readable instructions that may be executed to implement the processing at block 450 are shown in FIG. 6 and discussed in greater detail below.

After processing at block 450 completes, control proceeds to block 460 at which the example data authenticator 300 determines whether verification of the authenticity of the input data obtained at block 410 was successful. If verification of the input data's authenticity was unsuccessful (block 460), control proceeds to block 440. At block 440, the example data authenticator 300 outputs an indication that the input data obtained at block 410 was not able to be authenticated. Additionally, the example data authenticator outputs the key ID corresponding to the input public key obtained at block 410 to indicate for which of the plurality of possible public keys authentication of the input data was unsuccessful. Execution of the example machine readable instructions 400 then ends.

However, if verification of the input data's authenticity was successful (block 460), control proceeds instead to block 470. At block 470, the example data authenticator 300 outputs an indication that the input data obtained at block 410 is authentic. Additionally, the example data authenticator outputs the key ID corresponding to the input public key obtained at block 410 to indicate for which of the plurality of possible public keys authentication of the input data was successful. Execution of the example machine readable instructions 400 then ends.

Example machine readable instructions 420 that may be executed to perform key verification to implement the processing at block 420 of FIG. 4 and/or the example key verifier 340 of FIG. 3 are shown in FIG. 5. Execution of the example machine readable instructions 420 of FIG. 5 begins at block 510 at which a data authenticator, such as, for example, the example data authenticator 300 of FIG. 3, determines a hashed key value corresponding to an input public key (e.g., such as the input public key obtained at block 410 of FIG. 4) to be used for data authentication. For example, if the input public key is denoted as Nₖ, then at block 510 the example input hash processor 350 included in the example data authenticator 300 may determine a hashed key value given by Xₖ=HASH(Nₖ), where HASH( ) denotes any hash function.

Next, control proceeds to block 520 at which the example data authenticator 300 concatenates the hashed key value determined at block 510 for the input public key with a plurality of hashed key values corresponding to the plurality of other possible public keys that could be used for data authentication. Furthermore, at block 510 the concatenation is performed in a predetermined order based on a key ID identifying where to insert the hashed key value corresponding to the input public key in the concatenation sequence. For example, at block 520 the example concatenator 355 included in the example data authenticator 300 may perform the concatenation as follows. First, assume that the key identifier has a value of k indicating that the k^{th} public key (denoted as Nₖ) in the plurality of possible public keys is being used for data authentication (e.g., as obtained at block 410 of FIG. 4). Next, assume that the input plurality of hashed key values is denoted as hNⱼ=HASH(Nj), j=1, . . . , n and j≠k, where the plurality of possible public keys is denoted as Nⱼ, j=1, . . . , n. Then, at block 520 the example concatenator 355 produces a concatenation result given by hN₁∥hN₂∥ . . . ∥Xₖ∥ . . . ∥hNₙ, where Xk is the hashed key value determined at block 510 for the input public key, and “∥” denotes concatenation.

Control then proceeds to block 530 at which the example data authenticator 300 determines a test composite hashed key value by processing the concatenation result determined at block 520 with a hash function. The hash function implemented by the example data authenticator 300 at block 530 may be the same as or different from the hash function implemented at block 510. For example, using the preceding notation, at block 530 the example composite hash processor 360 included in the example data authenticator 300 may determine a test composite hashed value given by T=HASH(hN₁∥hN₂∥ . . . ∥Xₖ∥ . . . ∥hNₙ).

After the test composite hashed value is determined at block 530, control proceeds to block 540 at which the example data authenticator 300 compares the test composite hashed value with a reference composite hashed value. As discussed above, the reference composite hashed key value is a known value determined by concatenating all of the plurality of possible public key values and then processing the result with a hash function equivalent to the hash function implemented at block 540. For example, using the preceding notation, the reference composite hashed value is given by hKEYS=HASH(hN₁∥hN₂∥ . . . ∥hNₖ∥ . . . ∥hNₙ). Thus, if the input public key is an authentic one of the plurality of possible public keys, then the hashed key value determined at block 510 (e.g., Xₖ) will be equivalent to the corresponding hashed key value (e.g., hNₖ) used to generate the reference composite hashed key value. In that case, the test composite hashed key value (e.g., T) will match (at least substantially) the reference composite hashed value (e.g., hKEYS).

Returning to the example of FIG. 5, at block 540 the comparison of the test composite hashed key value (e.g., T) and the reference composite hashed value (e.g., hKEYS) may be performed by, for example, the example comparator 365 included in the example data authenticator 300. Next, at block 550 the example data authenticator 300 determines whether the comparison performed at block 550 yielded a match. If the test composite hashed key value (e.g., T) and the reference composite hashed value (e.g., hKEYS) match (at least substantially) (block 550), control proceeds to block 560 at which the example data authenticator 300 indicates that the authenticity of the input public key has been verified. If, however, the test composite hashed key value (e.g., T) and the reference composite hashed value (e.g., hKEYS) do not match (at least substantially) (block 550), control proceeds to block 570 at which the example data authenticator 300 indicates that the authenticity of the input public key has not been verified. Execution of the example machine readable instructions 420 then ends.

Example machine readable instructions 450 that may be executed to perform data verification to implement the processing at block 450 of FIG. 4 and/or the example data verifier 345 of FIG. 3 are shown in FIG. 6. Execution of the example machine readable instructions 450 of FIG. 6 begins at block 610 at which a data authenticator, such as, for example, the example data authenticator 300 of FIG. 3, obtains the input public key to be used for data authentication. For example, the input public key may be obtained at block 410 of FIG. 4. Next, control proceeds to block 620 at which the example data authenticator 300 performs public key authentication on the input data (e.g., such as the input data obtained at block 410 of FIG. 4) using the input public key obtained at block 610. For example, at block 620 the example authentication processor 375 included in the example data authenticator 300 may implement any public key authentication algorithm to authenticate the input data. In such an example, at block 620 the example authentication processor 375 may use the input public key obtained at block 510 to decrypt, according to the public key authentication algorithm, an input signature (e.g., such as the input signature obtained at block 410 of FIG. 4) used to sign the input data being authenticated. The example authentication processor 375 in this example also processes the input data at block 620 to generate an intermediate value that would have been encrypted by a legitimate provider of the data to generate the input signature. Then, in this example, if the intermediate value matches (at least substantially) the decrypted input signature, the example authentication processor 375 determines at block 620 that the input data is authentic because the input signature corresponds to the input public key and the input data.

Thus, at block 630 the example data authenticator 300 determines whether the public key authentication processing at block 620 indicates that the input data is authentic. If the input data is authentic (block 630), control proceeds to block 640 at which the example data authenticator 300 indicates that the authenticity of the input data has been verified. If, however, the input data is not authentic (block 630), control proceeds to block 650 at which the example data authenticator 300 indicates that the authenticity of the input data has not been verified. Execution of the example machine readable instructions 450 then ends.

Persons having ordinary skill in the art will appreciate that the example data authentication system 100 of FIG. 1, the example data authentication system 200 of FIG. 2, the example data authenticator 300 of FIG. 3 and the example machine readable instructions of FIGS. 4-6 illustrate methods and apparatus for data authentication with multiple keys. Such methods and apparatus may be used in a wide variety of applications. For example, the methods and/or apparatus illustrated herein support data authentication applications in which the keys used to authenticate the data may be revised, refreshed, revoked, compromised, etc. For example, the methods and/or apparatus illustrated herein support key revision by enabling a first key to be used to authenticate data during a first time, and then a second key to be used to authenticate data during a second time. Additionally, the first time and the second time may be predetermined to define refresh intervals such that the first key must be refreshed (e.g., updated) by the second key after the first interval of time expires in order for authentication of the data to be considered valid by, for example, a higher-level application (e.g., such as the example controller 260 of FIG. 2) using the results of the data authentication methods and/or apparatus illustrated herein.

Additionally or alternatively, if key revocation is to be supported, the methods and/or apparatus illustrated herein can be augmented to include, for example, an expiration date with one or more of the keys in the plurality of keys capable of supporting data authentication. In this way, a higher-level application (e.g., such as the example controller 260) using the results of the data authentication methods and/or apparatus illustrated herein can examine the expiration date(s) to determine whether data authentication based on one or more of the plurality of keys is valid. Additionally or alternatively, the methods and/or apparatus illustrated herein can support scenarios in which a private key associated with a legitimate data provider is compromised. In such a scenario, a higher-level application (e.g., such as the example controller 260) using the results of the data authentication methods and/or apparatus illustrated herein can determine whether data authentication was performed with a public key corresponding to a compromised private key and, if so, indicate that data authentication is invalid for the public key.

FIG. 7 is a block diagram of an example computer 700 capable of implementing the apparatus and methods disclosed herein. The computer 700 can be, for example, a server, a personal computer, a personal digital assistant (PDA), an Internet appliance, a DVD player, a CD player, a digital video recorder, a personal video recorder, a set top box, or any other type of computing device.

The system 700 of the instant example includes a processor 712 such as a general purpose programmable processor. The processor 712 includes a local memory 714, and executes coded instructions 716 present in the local memory 714 and/or in another memory device. The processor 712 may execute, among other things, the machine readable instructions represented in FIGS. 4-6. The processor 712 may be any type of processing unit, such as one or more microprocessors from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 712 is in communication with a main memory including a volatile memory 718 and a non-volatile memory 720 via a bus 722. The volatile memory 718 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 720 may be implemented by flash memory and/or any other desired type of memory device. Access to the main memory 718, 720 is typically controlled by a memory controller (not shown) in a conventional manner.

The computer 700 also includes a conventional interface circuit 724. The interface circuit 724 may be implemented by any type of well known interface standard, such as an Ethernet interface, a universal serial bus (USB), and/or a third generation input/output (3GIO) interface.

One or more input devices 726 are connected to the interface circuit 724. The input device(s) 726 permit a user to enter data and commands into the processor 712. The input device(s) can be implemented by, for example, a keyboard, a mouse, a touchscreen, a track-pad, a trackball, an isopoint and/or a voice recognition system.

One or more output devices 728 are also connected to the interface circuit 724. The output devices 728 can be implemented, for example, by display devices (e.g., a liquid crystal display, a cathode ray tube display (CRT)), by a printer and/or by speakers. The interface circuit 724, thus, typically includes a graphics driver card.

The interface circuit 724 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 700 also includes one or more mass storage devices 730 for storing software and data. Examples of such mass storage devices 730 include floppy disk drives, hard drive disks, compact disk drives and digital versatile disk (DVD) drives. The mass storage device 730 may implement the example key storage unit 370 of FIG. 3. Alternatively, the volatile memory 718 may implement the example key storage unit 370.

As an alternative to implementing the methods and/or apparatus described herein in a system such as the device of FIG. 7, the methods and or apparatus described herein may be embedded in a structure such as a processor and/or an ASIC (application specific integrated circuit).

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An apparatus to authenticate data, the apparatus comprising
a key verifier to verify a first key by comparing a test composite key value and a reference composite key value, wherein the test composite key value is generated from a first key value corresponding to the first key and a second key value corresponding to a second key; and
a data verifier to verify the data using the first key when the key verifier determines that verification of the first key was successful, wherein verification is successful when the test composite key value substantially matches the reference composite key value.

2. An apparatus as defined in claim 1 wherein the data comprises program code.

3. An apparatus as defined in claim 1 wherein the first key comprises a first public key for use with a public key encryption algorithm.

4. An apparatus as defined in claim 1 wherein the first value comprises a hash value determined by processing the first public key with a hash function.

5. An apparatus as defined in claim 1 further comprising a first input to obtain the first key and a second input to obtain the second key value.

6. An apparatus as defined in claim 1 further comprising a first input to obtain the first key and a second input to obtain at least one of the data or a signature corresponding to the data.

7. An apparatus as defined in claim 1 further comprising an output to indicate at least one of whether verification of the first key was successful or whether verification of the data was successful.

8. An apparatus as defined in claim 1 wherein the reference composite key value is stored in read-only memory.

9. An apparatus as defined in claim 1 wherein the first key and the second key have different lengths.

10. An apparatus as defined in claim 1 wherein the key verifier comprises:
a hash processor to determine the first value corresponding to the first key;
a concatenator to concatenate the first value and the second value to determine a concatenation result; and
a comparator to compare the test composite key value and the reference composite key value, wherein the test composite key value is based on the concatenation result.

11. An apparatus as defined in claim 10 wherein the concatenation result is processed by a hash function to determine the test composite key value.

12. An apparatus as defined in claim 1 wherein the data verifier comprises an authenticator to authenticate the data using a public key encryption algorithm and wherein a public key for use with the public key encryption algorithm comprises the first key.

13. A method to authenticate data comprising
determining a first key value corresponding to a first key;
determining a test composite key value based on a concatenation of at least the first key value and a second key value corresponding to a second key:
verifying the first key based on a comparison of the test composite key value with a reference composite key value; and
verifying the data according to an authentication algorithm when verification of the first key is successful.

14. A method as defined in claim 13 wherein the first key value comprises a hash value determined by processing the first key with a hash function.

15. A method as defined in claim 13 wherein the first key comprises a first public key for use with a public key encryption algorithm.

16. A method as defined in claim 13 wherein the test composite key value is determined by processing the concatenation of the at least the first key value and the second key value with a hash function.

17. A method as defined in claim 13 wherein verifying the first key comprises indicating that verification was successful when the test composite key value and the reference composite key value substantially match.

18. A method as defined in claim 13 wherein the predetermined authentication algorithm comprises a public key encryption algorithm.

19. A method as defined in claim 18 wherein the first key comprises a public key and verifying the data comprises processing the data with the public key encryption algorithm based on the public key.

20. A method as defined in claim 13 wherein the first key comprises a first number of bits and the second key comprises a second number of bits different from the first number of bits.

21. A method as defined in claim 13 wherein the authentication algorithm corresponds to a first type of authentication algorithm when an input identifier has a first identification value and wherein the authentication algorithm corresponds to a second type of authentication algorithm when the input identifier has a second identification value.

22. An article of manufacture storing machine readable instructions which, when executed, cause a machine to:
determine a first key value corresponding to a first key;
determine a test composite key value based on a concatenation of at least the first key value and a second key value corresponding to a second key:
verify the first key based on a comparison of the test composite key value with a reference composite key value; and
verify the data is authentic according to an authentication algorithm when verification of the first key is successful.

23. An article of manufacture as defined in claim 22 wherein the machine readable instructions, when executed, further cause the machine to verify the first key by indicating that verification was successful when the test composite key value and the reference composite key value substantially match.

24. An article of manufacture as defined in claim 22 wherein the predetermined authentication algorithm comprises a public key encryption algorithm.

25. An article of manufacture as defined in claim 24 wherein the first key comprises a public key and wherein the machine readable instructions, when executed, further cause the machine to verify the data by processing the data with the public key encryption algorithm based on the public key.

26. A system to process authenticated data, the system comprising
a data authenticator to determine whether data is authentic based on a first key from a set of keys, wherein the data authenticator comprises:
a key verifier to verify the first key based on a concatenation of a plurality of key values, wherein the plurality of key values includes a first key value corresponding to the first key; and
a data verifier to verify the data according to a public key encryption algorithm using a public key, wherein the data verifier is configured to verify the data when the key verifier indicates that verification of the first key was successful and wherein the data verifier is configured to indicate that the data is authentic when verification of the data is successful; and
a data processor to determine whether the data is valid based on whether the data authenticator determines the data is authentic and whether the first key is valid.

27. A system as defined in claim 26 wherein the plurality of key values comprises a plurality of hash values and wherein the first key value comprises a first hash value.

28. A system as defined in claim 26 wherein the public key comprises the first key.

29. A system as defined in claim 26 wherein the data processor is configured to determine the data is valid when the data authenticator determines the data is authentic and when the data processor determines the first key has not been revoked.

30. A system as defined in claim 26 wherein the data processor is configured to not process the data unless the data is determined to be valid.
